(19) United States
(12) Patent Application Publication
(10) Pub. No.: US 2014/0146884 A1
(43) Pub. Date: May 29, 2014

(54) FAST PREDICTION MODE DETERMINATION METHOD IN VIDEO ENCODER BASED ON PROBABILITY DISTRIBUTION OF RATE-DISTORTION

(71) Applicant: Electronics and Telecommunications Research Institute, (US)

(72) Inventors: Seung Hyun CHO, Daejeon (KR); Hyun Mi KIM, Incheon (KR); Seong Mo PARK, Daejeon (KR); Ig Kyun KIM, Daejeon (KR); Kyoung Seon SHIN, Daejeon (KR); Kyung Jin BYUN, Daejeon (KR)

(73) Assignee: Electronics and Telecommunications Research Institute, Daejeon (KR)

(21) Appl. No.: 13/765,263

(22) Filed: Feb. 12, 2013

(30) Foreign Application Priority Data
Nov. 26, 2012 (KR) 10-2012-0134287

(51) Int. Cl. H04N 7/26

(52) U.S. Cl. CPC H04N 19/00569
USPC 375/240.12

(57) ABSTRACT

The present invention provides a fast prediction mode determination method of a video encoder that may remove an unnecessary operation of an encoder by selectively terminating early or omitting a splitting process and a pruning process based on a probability distribution of rate-distortion values, and thereby enables the encoder to quickly determine a prediction mode. The present invention may include a method that may adaptively change a termination and omission determination criterion of the splitting process and the pruning process based on a characteristic of an input image. When using the method provided by the present invention, reliability regarding the termination and omission determination of the splitting process and the pruning process may be set and thus, it is possible to adjust the tradeoff between a decrease in an operation amount and a quality degradation of the encoder.

### CROSS-REFERENCE TO RELATED APPLICATIONS

This application claims priority to and the benefit of Korean Patent Application No. 10-2012-0134287 filed in the Korean Intellectual Property Office on Nov. 26, 2012, the entire contents of which are incorporated herein by reference.

### TECHNICAL FIELD

The present invention relates to a fast encoding technology of a video signal, and more particularly, to a technology of using a probability distribution of rate-distortion costs in order to accelerate prediction mode determination during an encoding process of an encoder.

### BACKGROUND ART

Current video compression standards have been designed to enable intra screen prediction or inter screen prediction of various block sizes in order to effectively encode a video signal. For example, an H.264/advanced video coding (AVC) standard may divide a single 16×16 macro block into blocks having a size of 16×16, 16×8, 8×16, 8×8, 8×4, 4×8, or 4×4, and thereby perform prediction. Currently, a technology of predicting a video signal using further various blocks sizes compared to a related art is applied. Therefore, a high efficiency video coding (HEVC) standard having quad-tree coding structure is expected to perform prediction into various sizes ranging from a maximum of 64×64 to a minimum of 4×4.

FIG. 1 illustrates an example of a prediction block size available in an HEVC video compression standard. In FIG. 1, a numerical number denotes the number of luminance pixels. In HEVC, a coding unit (CU) with a 2N×2N size that is split into a quad-tree form may be predicted as a single 2N×2N prediction unit (PU), two 2N×N PUs, two N×2N PUs, or four N×N PUs (for example, N=32, 16, 8, 4, etc.).

A process of finding an optimal combination having the most excellent coding efficiency among combinations of prediction blocks with various sizes may be classified into (i) a splitting process and (ii) a pruning process. Initially, through the splitting process, prediction is performed for each size while splitting the largest block into small blocks and a rate-distortion value according thereto is stored. After repeating the above operation up to the smallest block, a sum of rate-distortion values of the smallest blocks is obtained and the obtained sum is compared with a rate-distortion value of a single upper block and thereby a smaller value therebetween is selected through the pruning process.

FIGS. 2 and 3 illustrate a splitting process and a pruning process applicable in order to determine optimal CU splitting in an HEVC video compression standard, respectively. As indicated by an arrow indicator in FIG. 2, the splitting process is a process of obtaining a rate-distortion value of CU₀(200) of which CU depth is N and then obtaining a rate-distortion value with respect to each of CU_{1,0}(210), CU_{1,1}(211), CU_{1,2}(212), and CU_{1,0}(213) of which CU depth is (N+1) and that are four lower CUs of CU₀(200). The splitting process may be performed in a top-down depth-first order, starting from the largest CU up to the smallest CU. The pruning process of FIG. 3 is a process of determining whether to split an area of CU₀(300) by comparing a rate-distortion value of CU₀(300) with a sum of rate-distortion values of four lower CU_{1,0}(310), CU_{1,1}(3¹¹), CU_{1,2}(312), and CU_{1,3}(313) and thereby selecting a smaller value therebetween. Contrary to the splitting process, the pruning process may be performed in a bottom-up depth-first order from the smallest CU up to the largest CU.

In general, according to an increase and diversification in a prediction block size, compression efficiency is enhanced. Compression efficiency about a high definition video signal of FULL-HD, UHD, and the like, is improved. However, combinations of probable prediction blocks also further increase and thus, an operation amount of an encoder used to determine the optimal prediction mode significantly increases. In the case of HEVC, when a depth of 64×64 largest CU (LCU) is “0”, four (32×32) CUs may be present in depth 1, 16 (16×16) CUs may be present in depth 2, and 64 (8×8) CUs may be present in depth 3. Each 8×8 CU may be split to PUs having a size such as 8×8, 8×4, 4×8, 4×4, and the like, and thereby be predicted. To determine the most optimal prediction mode, intra screen prediction and inter screen prediction need to be performed with respect to all of CU depths and PU splitting during the aforementioned splitting process and pruning process, which significantly increases an operation amount of an encoder.

### SUMMARY OF THE INVENTION

The present invention has been made in an effort to provide a fast prediction mode determination method of a video encoder that may remove an unnecessary operation of an encoder by selectively terminating early or omitting a splitting process and a pruning process based on a probability distribution of rate-distortion values, and thereby enables the encoder to quickly determine a prediction mode.

The present invention may include a method that may adaptively change a termination and omission determination criterion of the splitting process and the pruning process based on a characteristic of an input image. When using the method provided by the present invention, reliability regarding the termination and omission determination of the splitting process and the pruning process may be set and thus, it is possible to adjust the tradeoff between a decrease in an operation amount and a quality degradation of the encoder.

An exemplary embodiment of the present invention provides a fast prediction mode determination method of a video encoder, the method including: an early splitting test process of determining an early split coding unit (CU) through comparison between a first rate-distortion value and a first threshold with respect to candidate prediction modes that are selected by calculating the first rate-distortion value with respect to each prediction unit (PU) split mode in a single CU of an intra screen image or an inter screen image; and an early pruning test process of determining an early pruned CU through comparison between a second rate-distortion value and a second threshold with respect to a candidate prediction mode that does not correspond to the early split CU.

The early split CU may be a CU in which calculation of the second rate-distortion value is omitted from a pruning process, and the early pruned CU may be a CU in which a splitting process and a pruning process with respect to remaining lower CUs are omitted.

The first rate-distortion value J_{LRD} may be calculated according to equation J_{LRD}=DIST_{LRD}+λ_{pred}·R_{pred}, and the second rate-distortion value J_{FRD} may be calculated according to equation J_{FRD}=DIST_{FRD}+λ_{mode}·R_{mode}. Here, DIST_{LRD} may denote a sum of absolute differences (SAD) or a sum of absolute Hadamard transformed differences (SAID) based on a luminance pixel value of an image in a corresponding prediction mode, λ_{pred} may denote a Lagrangean multiplier in the corresponding prediction mode, R_{pred} may denote a bit amount occurring due to usage of the corresponding prediction mode, DIST_{FRD} may denote a sum of absolute error (SSE) based on a luminance pixel value of an image in a corresponding prediction mode, λ_{mode} may denote a Lagrangean multiplier in the corresponding prediction mode, and R_{mode} may denote a bit amount occurring due to usage of the corresponding prediction mode.

In the early splitting test process, when the first rate-distortion value is greater than the first threshold, a corresponding prediction mode may be determined as the early split CU. In the early pruning test process, when the second rate-distortion value is less than the second threshold, the corresponding prediction mode may be determined as the early pruned CU.

In the early pruning test process, a corresponding second rate-distortion value with respect to the early split CU may be replaced with a summed value of second rate-distortion values of the respective lower split modes.

The first threshold and the second threshold may be respectively updated based on a distribution of the first rate-rate distortion value and a distribution of the second rate-distortion value that are obtained periodically or intermittently at a predetermined time.

The first threshold and the second threshold may be updated per a predetermined frame.

The first threshold and the second threshold may be updated based on a Bayesian rule.

A value that satisfies a conditional probability value α given through the Bayesian rule within an error range ε may be determined as the first threshold or the second threshold.

Another exemplary embodiment of the present invention provides a video encoder, including: an early splitting test means to perform an early splitting test process of determining an early split CU through comparison between a first rate-distortion value and a first threshold with respect to candidate prediction modes that are selected by calculating the first rate-distortion value with respect to each PU split mode in a single CU of an intra screen image or an inter screen image; and an early pruning test means to perform an early pruning test process of determining an early pruned CU through comparison between a second rate-distortion value and a second threshold with respect to a candidate prediction mode that does not correspond to the early split CU.

The early split CU may be a CU in which calculation of the second rate-distortion value is omitted from a pruning process, and the early pruned CU may be a CU in which a splitting process and a pruning process with respect to remaining lower CUs are omitted.

The early splitting test means may calculate the first rate-distortion value J_{LRD}, according to equation J_{LRD}=D_{LRD}+λ_{pred}·R_{pred}, and may calculate the second rate-distortion value J_{FRD} according to equation J_{FRD}=DIST_{FRD}+λ_{mode}·R_{mode}. Here, DIST_{LRD} may denote a SAD or an SATD based on a luminance pixel value of an image in a corresponding prediction mode, λ_{pred} may denote a Lagrangean multiplier in the corresponding prediction mode, R_{pred} may denote a bit amount occurring due to usage of the corresponding prediction mode, DIST_{FRD} may denote an SSE based on a luminance pixel value of an image in a corresponding prediction mode, λ_{mode} may denote a Lagrangean multiplier in the corresponding prediction mode, and R_{mode} may denote a bit amount occurring due to usage of the corresponding prediction mode.

When the first rate-distortion value is greater than the first threshold, the early splitting test means may determine a corresponding prediction mode as the early split CU. When the second rate-distortion value is less than the second threshold, the early pruning test means may determine the corresponding prediction mode as the early pruned CU.

In the early pruning test process, a corresponding second rate-distortion value with respect to the early split CU may be replaced with a summed value of second rate-distortion values of the respective lower split modes.

The first threshold and the second threshold may be respectively updated based on a distribution of the first rate-rate distortion value and a distribution of the second rate-distortion value that are obtained periodically or intermittently at a predetermined time.

The first threshold and the second threshold may be updated per a predetermined frame.

The first threshold and the second threshold may be updated based on a Bayesian rule.

A value that satisfies a conditional probability value α given through the Bayesian rule within an error range ε may be determined as the first threshold or the second threshold.

According to exemplary embodiments of the present invention, a fast prediction mode determination method of a video encoder may omit or partially perform only a portion of an operation with respect to a prediction mode during a video encoding process using a standard in which size and type of prediction blocks are various. Accordingly, compared to an existing scheme, it is possible to significantly decrease an operation amount required to determine whether to split a block. According to the method provided by the present invention, it is possible to adjust a determination criterion for omitting or partially performing the operation for the prediction block and thus, a user may select a decrease in an operation amount and quality degradation according thereto.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example of a prediction block size available in a high efficiency video coding (HEVC) video compression standard.

FIG. 2 is an example of a splitting process applicable in order to determine optimal coding unit (CU) splitting in the HEVC video compression standard.

FIG. 3 is an example of a pruning process applicable in order to determine the optimal CU splitting in the HEVC video compression standard.

FIG. 4 is a flowchart to describe a fast prediction mode determination method to be applied to an HEVC encoder according to an exemplary embodiment of the present invention.

FIG. 5 is a diagram associated with a splitting process and a pruning process referred to in order to describe the fast prediction mode determination method of FIG. 4.

FIG. 6 illustrates a method of obtaining a distribution of periodical J_{LRD} and J_{FRD} values referred to in order to describe the fast prediction mode determination method of FIG. 4.

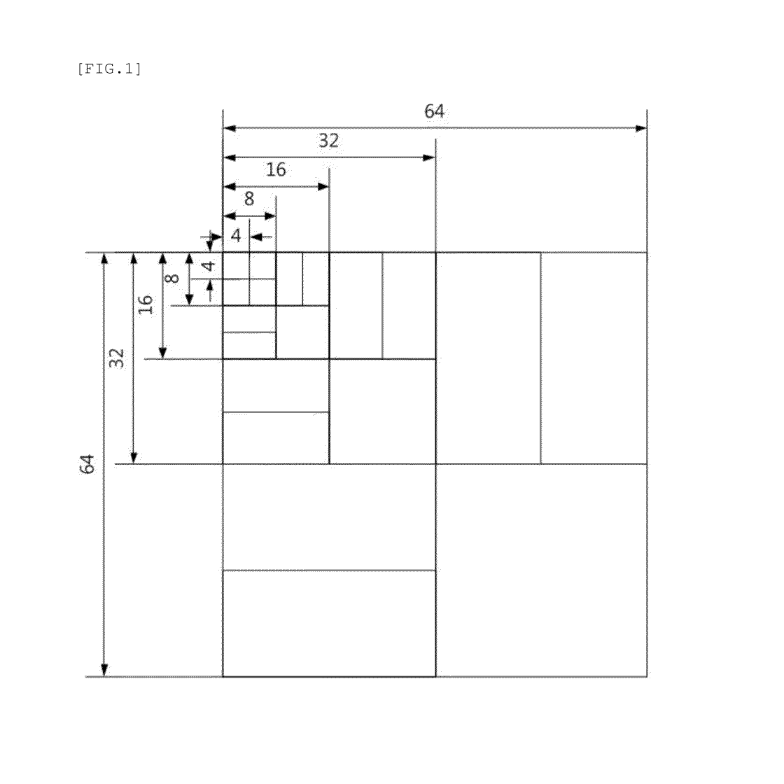

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. However, the present invention is not limited to or restricted by the exemplary embodiments.

As described above, the present invention may significantly decrease an operation amount required to determine whether to perform coding unit (CU) splitting and a prediction unit (PU) split mode by omitting or partially performing a splitting process or a pruning process with respect to a CU or a PU of a predetermined depth in an encoder for performing the splitting process and the pruning process. For the above operation, a distribution of rate-distortion values (costs) used for prediction mode determination in video encoding is modeled and used. In general, low complexity rate-distortion cost J_{LRD} is used for comparison between prediction modes in prediction blocks of the same size, that is, comparison between intra screen prediction modes of which prediction directions differ or comparison between inter screen prediction modes of which motion data differs, and is calculated according to Equation 1.

J_{LRD}=DIST_{LRD}+λ_{pred}·R_{pred} [Equation 1]

Here, a sum of absolute differences (SAD) and a sum of absolute Hadamard transformed differences (SAID) based on a luminance pixel value of an image in a corresponding prediction mode are used for a DIST_{LRD} value, λ_{pred} denotes a Lagrangean multiplier, and R_{pred} denotes an approximate bit amount occurring due to usage of the corresponding prediction mode. By considering calculation complexity, a residual signal, that is, residual is not considered or is modeled from other values.

Next, to determine a final prediction mode of a prediction block, precise rate-distortion cost J_{LRD} is used for rate-distortion cost comparison between prediction blocks of different sizes or comparison between different prediction modes, that is, to compare an intra screen prediction mode, an inter screen prediction mode that transmits motion data and a residual signal, and an inter screen prediction mode that does not transmit motion data and a residual signal, and the like, and is calculated according to Equation 2.

J_{FRD}=DIST_{FRD}+λ_{mode}·R_{mode} [Equation 2]

Here, a sum of absolute error (SSE) based on a luminance pixel value of an image is used for a DIST_{FRD} value according to a prediction mode, λ_{mode} denotes a Lagrangean multiplier, and R_{mode} denotes a bit amount occurring due to usage of a corresponding prediction mode and corresponds to the number of actually occurred bits that is calculated by performing entropy coding of a coefficient that is obtained by performing conversion, quantization, inverse conversion, and inverse quantization with respect to a residual signal for precision calculation.

Although J_{FRD} provides a more accurate rate-distortion cost value compared to J_{LRD}, it can be known from Equation 1 and Equation 2 that calculation of J_{FRD} is further complex compared to calculation of J_{LRD}. Depending on cases, J_{LRD} or relatively simple other calculation in a similar form may be used to determine a final prediction mode in order to decrease a calculation amount.

As an example of existing HEVC configuration using the aforementioned J_{LRD} and J_{FRD}, a method of selecting a candidate prediction mode by calculating J_{LRD} of each intra screen prediction direction with respect to all of the probable PU splitting in a CU of a predetermined depth and selecting the most optimal prediction mode by calculating J_{FRD} with respect to the candidate prediction modes may be considered in the splitting process. Similarly, even with respect to inter screen prediction, a candidate prediction mode is selected from among prediction modes having different motion data using J_{LRD} with respect to all of the probable PU splitting. Next, J_{FRD} is calculated with respect to the candidate prediction mode. J_{FRD} values of a prediction mode that does not transmit motion data and a prediction mode that transmits none of motion data and a residual signal are calculated.

By comparing the respective J_{fRD} values obtained as above, it is possible to perform PU splitting and prediction mode determination with respect to a corresponding CU. The above process is repeatedly performed with respect to CUs of all of the depths from an LCU up to a smallest CU (SCU). Next, in the pruning process, it is possible to determine whether to split all of the CUs within the LCU by repeating an operation of comparing a J_{FRD} sum of sub-CUs and J_{FRD} value of an upper CU of the same area from the SCU up to the LCU.

The present invention may be configured by additionally performing an early splitting test and an early pruning test while the encoder is performing the aforementioned splitting process. FIG. 4 is a flowchart to describe a fast prediction mode determination method to be applied to an HEVC encoder according to an exemplary embodiment of the present invention. In FIG. 4, for ease of description, the number of PU split modes available in a single CU with respect to intra screen prediction and inter screen prediction are assumed as P and Q within the intra screen prediction and the inter screen prediction, respectively.

Initially, in the early splitting test, a predetermined means (for example, an early splitting test means) of the encoder calculates J_{LRD} value (S111) with respect to each of P PU split modes in an intra screen image (an image for intra screen prediction having a predetermined number of pixels) and Q PU split modes in an inter screen image (an image for inter screen prediction having a predetermined number of pixels) (5110), in a CU of each depth, and selects candidate prediction modes within a predetermined range of the value (S112). When a current CU is not an SCU with respect to all of the candidate prediction modes (S113), the predetermined means of the encoder tests whether J_{LRD} value of each prediction mode is greater than a predetermined threshold J_{LRD}_{_{—}}_{TH} (S114). Otherwise, the predetermined means of the encoder calculates precise rate-distortion cost, that is, J_{FRD} with respect to the candidate prediction modes (S115) and thereby may determine an optimal prediction mode through the early pruning test (below S120) (S116). If so, calculation of the precise rate-distortion cost, that is, J_{FRD} required for the pruning process is omitted by predetermining that a CU of a corresponding prediction mode has a different PU split mode or will be split to four sub-CUs of a lower depth. The omitted J_{FRD} value may be allocated as the allowed largest value or a predetermined large value. When a CU of a predetermined prediction mode has J_{LRD} greater than J_{LRD}_{_{—}}_{TH} in all of the probable PU split modes, the CU of the predetermined prediction mode corresponds to an early split CU.

Meanwhile, only when the CU is not the early split CU, a predetermined means (for example, a pruning test means) of the encoder performs the early pruning test in order to determine an optimal prediction mode (S120) and tests whether J_{FRD} value of a predetermined prediction mode is less than a predetermined threshold J_{FRD}_{_{—}}_{TH} (S121). Otherwise, the predetermined means repeats the above process with respect to a sub-CU (S122) and may determine whether to further split the corresponding CU into a sub-CU (S123) and may store and manage rate-distortion cost of each CU in a storage means (S124). If so, the predetermined means of the encoder determines that the corresponding CU will not be further split to a sub-CU of a lower depth any more and thereby omits the splitting process and the pruning process with respect to the remaining lower CUs. The corresponding CU may be classified as an early pruned CU in order to be distinguished from other CUs.

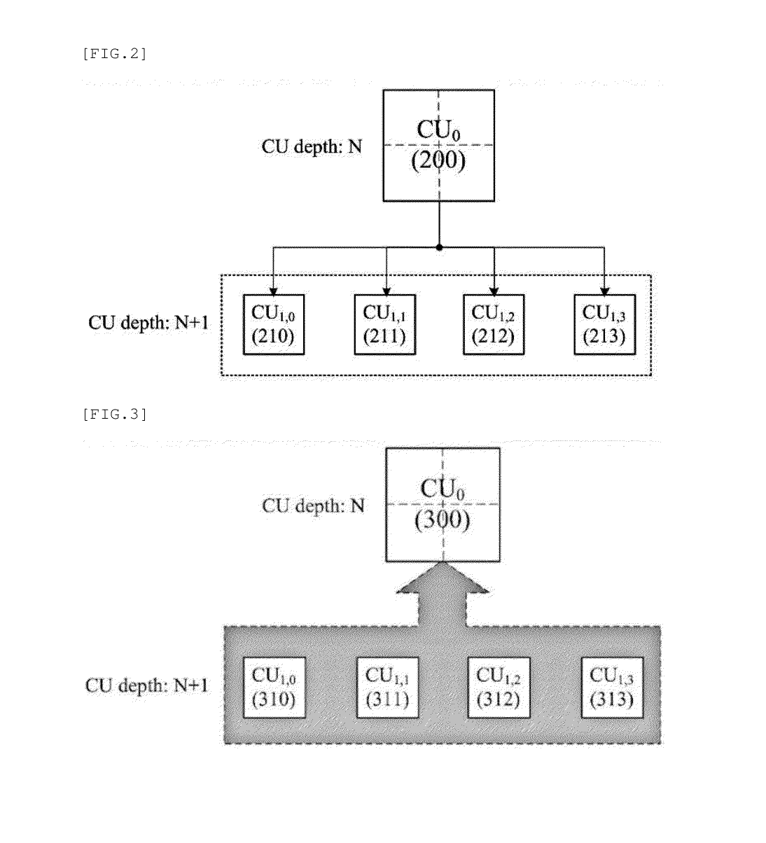

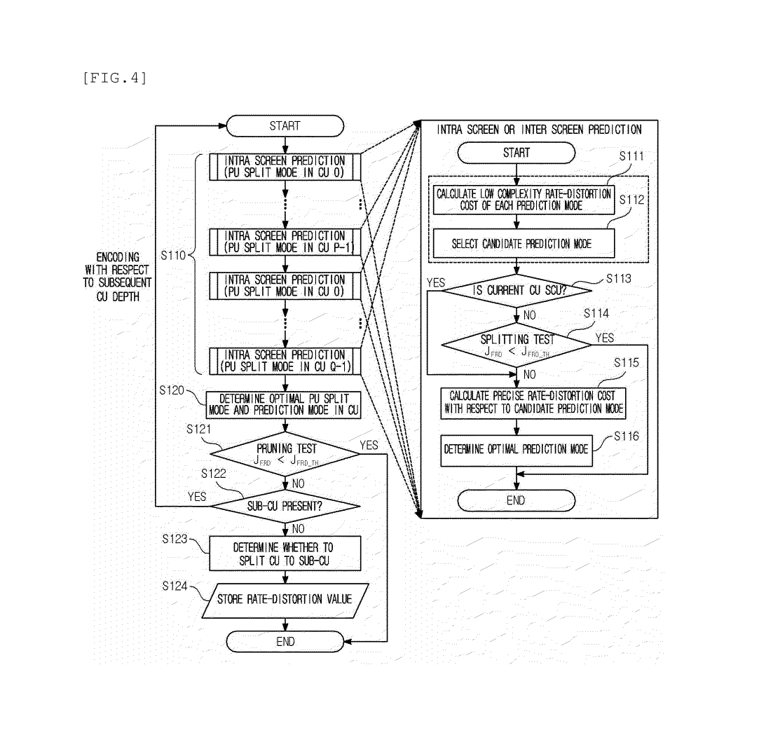

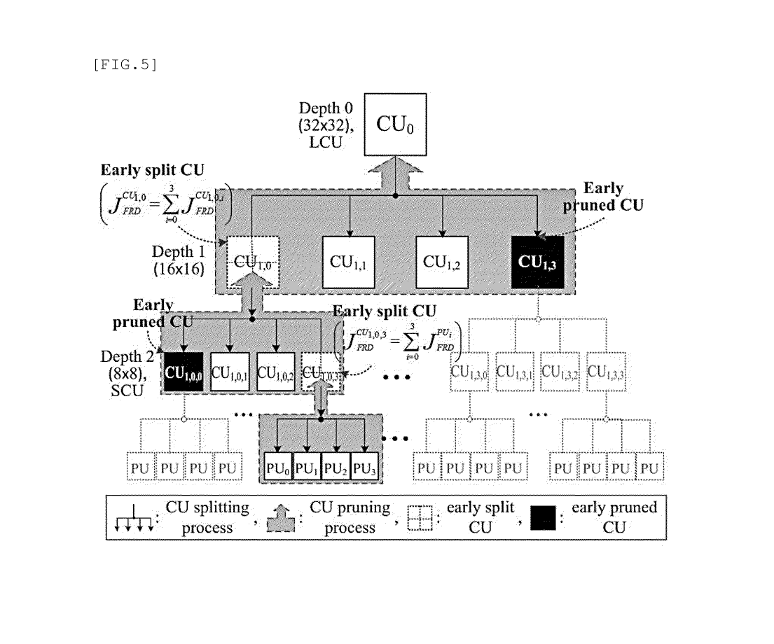

FIG. 5 illustrates a case in which an LCU size is 32×32 and an SCU size is 8×8 in an HEVC coding structure according to an exemplary embodiment of the present invention. Similar to FIGS. 2 and 3, a downward arrow indicator of FIG. 5 indicates a splitting process and an upward block arrow indicator indicates a pruning process. In FIG. 5, each of CU_{1,0} and CU_{1,0,3} is determined as an early split CU through the aforementioned splitting test (S114). During the pruning process, J_{FRD} value of CU_{1,0} is replaced with a sum of J_{FRD} values of CU_{1,0,0}, CU_{1,0,1}. CU_{1,0,2}, and CU_{1,0,3} that are sub-CUS. Similarly, J_{FRD} value of CU_{1,0,3} is replaced with a sum of J_{FRD} values of PU₀, PU₁, PU₂, and PU₃. Meanwhile, each of CU_{1,3} and CU_{1,0,0} is determined as an early pruned CU through the aforementioned early pruning test and thus, the splitting process and the pruning process with respect to a sub-CU or a PU split mode will be omitted.

J_{LRD}_{_{—}}_{TH} that is a determination criterion of the aforementioned early splitting test and J_{FRD}_{_{—}}_{TH} that is a determination criterion of the early pruning test may be obtained through a distribution of J_{LRD} values and a distribution of J_{FRD} values that are obtained for each prediction block size by pre-encoding an input image, or may be obtained by the distribution of J_{LRD} values and the distribution of J_{FRD} values periodically or intermittently at a predetermined time during an encoding process. To be applied to HEVC, J_{LRD} and J_{FRD} values are stored for each of a case in which a corresponding CU is split to sub-CUs or PUs smaller than the CU in the CU of each depth and a case in which the corresponding CU is not split and is predicted as a PU with the same size as the corresponding CU.

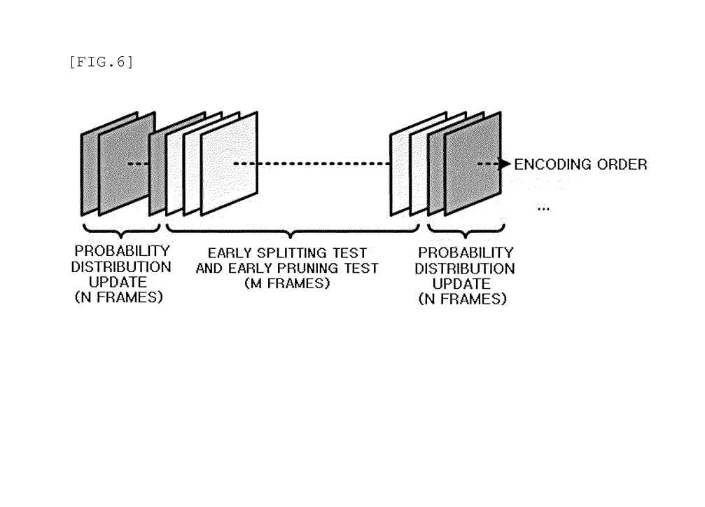

FIG. 6 illustrates a method of periodically obtaining distributions of J_{LRD} and J_{FRD} values. A probability distribution is updated by storing a distribution of each rate-distortion cost during N frames, which is periodically repeated. Through the updated probability distribution, J_{LRD}_{_{—}}_{TH} and J_{FRD}_{_{—}}_{TH} are determined. By performing an early splitting test and an early pruning test during M frames, an operation amount of an encoder used during the M frames is decreased.

Schemes to deduce a posterior probability from a prior probability are used to determine J_{LRD}_{_{—}}_{TH} and J_{FRD}_{_{—}}_{TH} through the distributions of J_{LRD} and J_{FRD}, respectively. As an example, a Bayesian rule may be used. In general, the Bayesian rule is expressed by Equation 3.

P(ωⱼ|x)=P(x|ωⱼ)·P(ωⱼ)/p(x) [Equation 3]

Here, x corresponds to J_{LRD} or J_{FRD} as a measurement value. In an event ωⱼ, j denotes, as “1” or “2”, a case in which a predetermined CU is split to sub-CUs or PUs smaller than the CU and thereby is predicted (j=1) and a case in which the predetermined CU is not split and is predicted as a PU having the same size as the corresponding CU (j=2). In Equation 3, p(x|ωⱼ) and P(ωⱼ) denote a conditional probability distribution and the prior probability, respectively, and are calculated like p(x)=ρⱼ₌₁²P(x|ωⱼ)·P(ωⱼ). p(x|ωⱼ) may be directly calculated from rate-distortion costs stored for each of the aforementioned criteria, or may be calculated by modeling a distribution of each rate-distortion cost. For example, it is possible to model the distribution of rate-distortion cost to a normalization distribution, a Laplacian distribution, and the like, and to calculate p(x|ωⱼ) from a corresponding model. Accordingly, when rate-distortion cost with respect to a predetermined prediction block is given, it is possible to obtain a probability that the prediction block may be or may not be split to a lower prediction block through Equation 3. On the contrary, it is possible to calculate rate-distortion cost that satisfies a given conditional probability value a within an approximate error range εJ_{LRD}_{_{—}}_{TH} and J_{FRD}_{_{—}}_{TH} may be calculated from the predefined α and ε, Equation 3, and an actual distribution of rate-distortion cost for each condition or an equation modeled therefrom, respectively.

Meanwhile, even though all of the constituent elements constituting the aforementioned exemplary embodiments of the present invention are described to be combined into a single module or to be combined and thereby operate, the present invention is not limited thereto. That is, without departing from the spirit of the present invention, all of the constituent elements may be selectively combined into at least one module and thereby operate. Even though each of all of the constituent elements may be configured as single independent hardware, a portion of or all of the constituent elements may be selectively combined and thereby be configured as a computer program having a program module that performs a portion or all of the combined functions in single or a plurality of hardware. The computer program may be stored in computer-readable media such as a universal serial bus (USB) memory, a CD disk, a flash memory, and the like, and thereby be read and executed by a computer, thereby embodying the exemplary embodiments of the present invention. Storage media of the computer program may include magnetic recording media, optical storage, media, carrier wave media, and the like.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A fast prediction mode determination method of a video encoder, the method comprising:
an early splitting test process of determining an early split coding unit (CU) through comparison between a first rate-distortion value and a first threshold with respect to candidate prediction modes that are selected by calculating the first rate-distortion value with respect to each prediction unit (PU) split mode in a single CU of an intra screen image or an inter screen image; and
an early pruning test process of determining an early pruned CU through comparison between a second rate-distortion value and a second threshold with respect to a candidate prediction mode that does not correspond to the early split CU.

2. The method of claim 1, wherein:
the early split CU is a CU in which calculation of the second rate-distortion value is omitted from a pruning process, and
the early pruned CU is a CU in which a splitting process and a pruning process with respect to remaining lower CUs are omitted.

3. The method of claim 1, wherein:
the first rate-distortion value J_{LRD} is calculated according to equation J_{LRD}=DIST_{LRD}+λ_{pred}·R_{pred}, and
the second rate-distortion value J_{FRD} is calculated according to equation J_{FRD}=DIST_{FRD}+λ_{mode}·R_{mode},
where DIST_{LRD} denotes a sum of absolute differences (SAD) or a sum of absolute Hadamard transformed differences (SAID) based on a luminance pixel value of an image in a corresponding prediction mode, λ_{pred} denotes a Lagrangean multiplier in the corresponding prediction mode, R_{pred} denotes a bit amount occurring due to usage of the corresponding prediction mode, DIST_{FRD} denotes a sum of absolute error (SSE) based on a luminance pixel value of an image in a corresponding prediction mode, λ_{mode} denotes a Lagrangean multiplier in the corresponding prediction mode, and R_{mode} denotes a bit amount occurring due to usage of the corresponding prediction mode.

4. The method of claim 1, wherein:
in the early splitting test process, when the first rate-distortion value is greater than the first threshold, a corresponding prediction mode is determined as the early split CU, and
in the early pruning test process, when the second rate-distortion value is less than the second threshold, the corresponding prediction mode is determined as the early pruned CU.

5. The method of claim 1, wherein in the early pruning test process, a corresponding second rate-distortion value with respect to the early split CU is replaced with a summed value of second rate-distortion values of the respective lower split modes.

6. The method of claim 1, wherein the first threshold and the second threshold are respectively updated based on a distribution of the first rate-rate distortion value and a distribution of the second rate-distortion value that are obtained periodically or intermittently at a predetermined time.

7. The method of claim 6, wherein the first threshold and the second threshold are updated per a predetermined frame.

8. The method of claim 6, wherein the first threshold and the second threshold are updated based on a Bayesian rule.

9. The method of claim 8, wherein a value that satisfies a conditional probability value α given through the Bayesian rule within an error range ε is determined as the first threshold or the second threshold.

10. A video encoder, comprising:
an early splitting test means to perform an early splitting test process of determining an early split CU through comparison between a first rate-distortion value and a first threshold with respect to candidate prediction modes that are selected by calculating the first rate-distortion value with respect to each PU split mode in a single CU of an intra screen image or an inter screen image; and
an early pruning test means to perform an early pruning test process of determining an early pruned CU through comparison between a second rate-distortion value and a second threshold with respect to a candidate prediction mode that does not correspond to the early split CU.

11. The video encoder of claim 10, wherein:
the early split CU is a CU in which calculation of the second rate-distortion value is omitted from a pruning process, and
the early pruned CU is a CU in which a splitting process and a pruning process with respect to remaining lower CUs are omitted.

12. The video encoder of claim 10, wherein:
the early splitting test means calculates the first rate-distortion value J_{LRD} according to equation J_{LRD}=DIST_{LRD}λ_{pred}·R_{pred}, and calculates the second rate-distortion value J_{FRD} according to equation J_{FRD}=DIST_{FRD}+λ_{mode}·R_{mode},
where DIST_{LRD} denotes a SAD or an SATD based on a luminance pixel value of an image in a corresponding prediction mode, λ_{pred} denotes a Lagrangean multiplier in the corresponding prediction mode, R_{pred} denotes a bit amount occurring due to usage of the corresponding prediction mode, DIST_{FRD} denotes an SSE based on a luminance pixel value of an image in a corresponding prediction mode, λ_{mode}, denotes a Lagrangean multiplier in the corresponding prediction mode, and R_{mode} denotes a bit amount occurring due to usage of the corresponding prediction mode.

13. The video encoder of claim 10, wherein:
when the first rate-distortion value is greater than the first threshold, the early splitting test means determines a corresponding prediction mode as the early split CU, and
when the second rate-distortion value is less than the second threshold, the early pruning test means determines the corresponding prediction mode as the early pruned CU.

14. The video encoder of claim 10, wherein in the early pruning test process, a corresponding second rate-distortion value with respect to the early split CU is replaced with a summed value of second rate-distortion values of the respective lower split modes.

15. The video encoder of claim 10, wherein the first threshold and the second threshold are respectively updated based on a distribution of the first rate-rate distortion value and a distribution of the second rate-distortion value that are obtained periodically or intermittently at a predetermined time.

16. The video encoder of claim 15, wherein the first threshold and the second threshold are updated per a predetermined frame.

17. The video encoder of claim 15, wherein the first threshold and the second threshold are updated based on a Bayesian rule.

18. The video encoder of claim 17, wherein a value that satisfies a conditional probability value α given through the Bayesian rule within an error range ε is determined as the first threshold or the second threshold.
